(19) United States
(12) Patent Application Publication
(10) Pub. No.: US 2009/0316760 A1
(43) Pub. Date: Dec. 24, 2009

(54) UWB APPARATUS AND METHOD

(76) Inventor: Desmond Phillips, Cambridge (GB)

Correspondence Address: REED SMITH LLP, P.O. BOX 488, PITTSBURGH, PA, 15230-0488, US

(21) Appl. No.: 12/442,926

(22) PCT Filed: Sep. 25, 2007
(86) PCT No.: PCT/GB07/03642

§ 371 Date: May 29, 2009

(30) Foreign Application Priority Data
Sep. 26, 2006 (GB) 0618992.2

(51) Int. Cl. H04B 1/707

(52) U.S. Cl. 375/147; 375/E01.002

(57) ABSTRACT

An ultra-wideband receiver for processing a received signal comprising two or more diversity signals formed using a spreading technique at a transmitter comprises channel estimation means for estimating the channel over which the signal was transmitted. The receiver comprises inverting means for inverting the channel estimate obtained from the channel estimation means, the inverse of the estimated channel being applied to the received signal to generate a compensated signal. The receiver comprises means fur weighting the compensated signal prior to demodulation using an estimate of noise in each channel, the estimate of the noise in each channel being derived from the inverse of the channel estimation process.

### TECHNICAL FIELD OF THE INVENTION

This invention relates to an ultra-wideband (UWB) apparatus and method, and in particular to an ultra-wideband apparatus and method of demodulating received ultra-wideband signals with a low error-rate.

### BACKGROUND OF THE INVENTION

Ultra-wideband is a radio technology that transmits digital data across a very wide frequency range, 3.1 to 10.6 GHz. It makes use of ultra low transmission power, typically less than −41 dBm/MHz, so that the technology can literally hide under other transmission frequencies such as existing Wi-Fi, GSM and Bluetooth. This means that ultra-wideband can co-exist with other radio frequency technologies. However, this has the limitation of limiting communication to distances of typically 5 to 20 metres.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 20 m of one another.

FIG. 1 shows the arrangement of frequency bands in a multi-band orthogonal frequency division multiplexing (MB-OFDM) system for ultra-wideband communication. The MB-OFDM system comprises fourteen sub-bands of 528 MHz each, and uses frequency hopping every 312 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organized into five band groups: four having three 528 MHz sub-bands, and one having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

The basic timing structure of a UWB system is a superframe. A superframe consists of 256 medium access slots (MAS), where each MAS has a defined duration, for example 256 μs. Each superframe starts with a Beacon Period, which lasts one or more contiguous MASs. The start of the first MAS in the beacon period is known as the “beacon period start”.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

With regard to the transmission of data from a transmitter to a receiver in a UWB system, to increase the energy per bit and also exploit diversity gain, time and frequency spreading are included In the MBOA UWB specification. At the transmitter, two copies, for example, of a single constellation point are transmitted into the channel (separated in time and/or frequency). At the receiver these multiple copies are recombined to optimise the signal-to-noise ratio (SNR) of the constellation point. Various techniques are known to combine the signals from multiple diversity branches. One such technique is Maximum Ratio Combining (MRC). FIG. 2 is a simplified schematic of a MRC despreading apparatus for combining received signals using the Maximum Ratio Combining technique. Multiple signal branches r₁ to r_{N} are each multiplied by a corresponding weight factor 3₁ to 3_{N}. The weighted signals 5₁ to 5_{N} are then added together in an adder 7 before being passed to a receiver demodulator 9. The purpose of MRC is to further amplify signal branches r₁ to r_{N} having a strong signal, while attenuating signal branches r₁ to r_{N} having weak signals.

One known approach for weighting the signal branches r₁ to r_{N} is to weight all signal branches r₁ to r_{N} equally. This approach produces demodulated data with a higher data rate, but also with a relatively high bit-error rate.

Another approach is to create a special circuit to estimate the noise magnitude in each received channel, which is then used to weight the received signals accordingly. This has the disadvantage that additional circuitry is required for determining the noise magnitude, which makes the receiver more expensive. The additional circuitry also has the disadvantage of increasing the power consumption of the receiver apparatus.

The aim of the present invention is to provide an improved UWB apparatus and method.

### SUMMARY OF INVENTION

According to a first aspect of the present invention, there is provided a method of processing a received signal, the received signal comprising two or more diversity signals formed using a spreading technique at a transmitter. The method comprises the steps of: estimating the channel over which the received signal was transmitted; applying the inverse of the estimated channel to the received signal, thereby generating a compensated signal and an estimate of the noise in each channel; and using the estimated noise in each channel, from the channel estimation process, to weight the inputs to demodulation of the compensated signal.

From the above it can be seen that the magnitude of noise in each of the MBOA UWB channels can be calculated as a by-product of the channel estimation process. Knowledge of the noise magnitude can be used to weight the inputs to demodulation, so that the lowest probability of error in the demodulated data is achieved.

According to another aspect of the present invention, there is provided a receiver for processing a received signal comprising two or more diversity signals formed using a spreading technique at a transmitter. The receiver comprises channel estimation means for estimating the channel over which the signal was transmitted, and inverting means for inverting the channel estimate obtained from the channel estimation means, the inverse of the estimated channel being applied to the received signal to generate a compensated signal. The receiver also comprises means for weighting the compensated signal prior to demodulation using an estimate of noise in each channel, the estimate of the noise in each channel being derived from the inverse of the channel estimation process.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the multi-band OFDM alliance (MBOA) approved frequency spectrum of a MB-OFDM system;

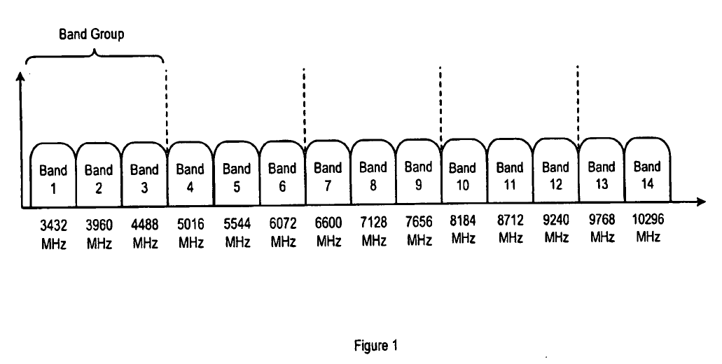

FIG. 2 is a schematic illustration of a basic Maximum Ratio Combining (MRC) technique; and

FIG. 3 is a schematic illustration of part of a receiver chain according to the present invention.

### DETAILED DESCRIPTION OF A PREFERRED EMBODIMENT OF THE INVENTION

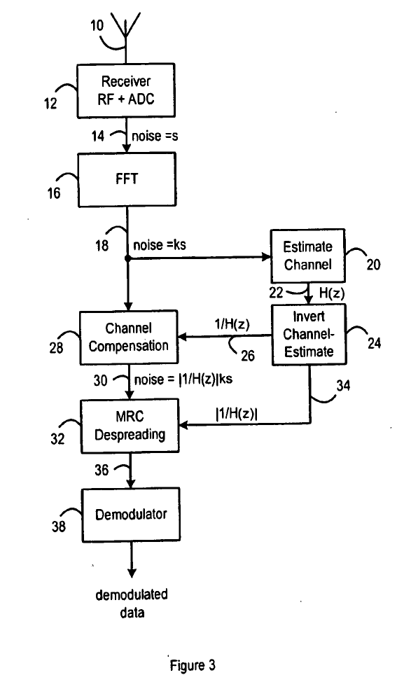

FIG. 3 is a schematic illustration of a receiver chain in an ultra-wideband apparatus, and shows the chain from the receiver block 12 up to the demodulator 38. Although the preferred embodiment is described in relation to an UWB receiver and method, it will be appreciated that the invention is equally applicable to other wireless communication systems in which data is transmitted using spreading and diversity techniques, and in particular, (but not exclusively), to OFDM systems in general using MBOA standards. An antenna 10 receives an input signal. The input signal is passed to a receiver block 12 comprising an RF stage and an analogue-to-digital converter (ADC). The receiver noise at the output 14 of the ADC is assumed to be white and Gaussian with a standard deviation, σ=s. The noise standard deviation at the output of the ADC 12 is mainly independent of the channel chosen, since it is dominated by thermal noise and noise from the low-noise amplifier (LNA) of the receiver.

The output 14 from the ADC 12 is passed to a Fast Fourier Transform stage (FFT) 16. The receiver noise standard deviation at the output 18 of the FFT 16 is increased by a factor k, (i.e. σ=ks), but again it is mainly independent of the channel.

The output 18 of the FFT 16 is passed to a channel-estimation block 20. The channel-estimation block 20 generates a channel estimate signal 22, i.e. H(z), of the channel over which the signal was transmitted. H(z) is a vector of complex numbers, each element representing the channel gain at an FFT subcarrier frequency. The channel estimate signal 22 is output to an inverting block 24 which generates the inverse of the estimated channel matrix, 1/H(z), 26.

The output 18 of the FFT 16 is further input to a channel-compensation block 28. The channel-compensation block 28 performs a compensation operation on the transformed signal 18 using the estimated inverse channel-matrix 26 received from the inverting block 24. In other words, the inverse channel-matrix 26 is applied to the transformed signal 18, thereby compensating for channel effects.

Applying the estimated inverse channel-matrix 26 to the transformed signal 18 increases the whole signal, including the channel noise, by |1/H(z)|, this being a factor which varies from channel to channel. The compensated signal 30 therefore has a noise factor of |1/H|ks.

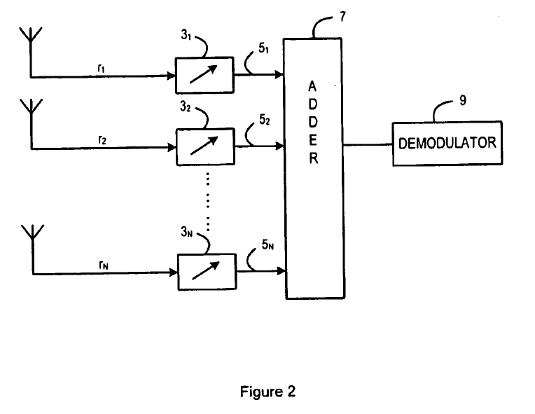

The compensated signal 30 is then output to a Maximum Ratio Combining (MRC) despreader 32. The despreader 32 despreads the compensated signal 30 according to the maximum ratio combining method described above in relation to FIG. 2, and which is further described in greater detail below.

To optimise signal-to-noise ratios, the standard deviations (a) of the constellation points in the received signal are required. As mentioned above, the assumption is that there is Additive White Gaussian Noise (AWGN) at the input to a fast Fourier transform (FFT) stage 16 in the receiver, which is shaped at the output by the channel-compensation block 28. Hence the magnitude of AWGN tone standard deviation (after the FFT and channel compensation) is proportional to the magnitude of 1/H(z), (i.e. the inverse of the estimated channel matrix).

The maximum ratio combining (MRC) technique provides the mathematical optimal way of utilising the sigma values in time and frequency despreading. The MRC technique is described by the equation below. Note that the sample values are xᵢ, and the corresponding sigma values are σ₁=|1/H(z)|ks

$$\hat{x} = {( {\sum }_{i = 1}^{N} \frac{1}{{σ}_{i}^{2}} )}^{- 1} {\sum }_{i = 1}^{N} \frac{{x}_{i}}{{σ}_{i}^{2}}$$

The standard deviation (σ) of the noise at the output of the MRC despreader is given by the equation:

$$σ ( \hat{x} ) = {( {\sum }_{i = 1}^{N} \frac{1}{{σ}_{i}^{2}} )}^{- \frac{1}{2}}$$

According to the invention, in order to perform this method, the MRC despreader 32 further receives as input a signal 34 of magnitude |1/H(z)| from the channel-estimate inversion block 24. The signal 26 (i.e. 1/H(z)) is calculated in the channel estimation and inversion stages 20, 24, with the signal 34 (i.e. |1/H(z)|) being calculated as part of the channel-compensation process (cf signal 26). Thus, it will be appreciated that very little extra processing is required to generate signal 34. In addition, it will be noted that the signal |1/H(z)|ks is accurately estimated to ensure optimal MRC. It will also be appreciated that the signal 34 represents a plurality of weight factors, one for each of the FFT subcarriers which are processed independently.

It is noted that the inverse of the channel estimate provides an indication of the noise level in the following manner. The Additive White Gaussian Noise (AWGN) is assumed to be spectrally “flat” prior to channel compensation (i.e. equal energy at all levels). After channel compensation (in frequency domain, after FFT), this constant noise power is either boosted or attenuated by the magnitude of the inverse channel estimate on each FFT subcarrier.

The MRC despreader 32 outputs the despread signal 36 to a demodulator 38, which further outputs the demodulated data.

From the above it can be seen that the magnitude of noise in each of the MBOA UWB channels can be calculated as a by-product of the channel estimation process. Knowledge of the noise magnitude is then used to weight the inputs to demodulation, so that the lowest probability of error in the demodulated data is achieved.

Thus, the present invention provides a method of demodulating a received signal that produces a lower error rate on the demodulated signal. This performance advantage is achieved without significant extra cost because the magnitude of the noise is already calculated as a natural part of channel estimation process. In other words, the noise magnitude for the Maximum Ratio Combining operation is computed “for free” as part of the process of channel estimation.

The invention has the advantage of enabling higher performance to be achieved, either through lower error-rates at a given range, or longer range at a given error-rate, but without increased cost or power consumption.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of processing a received signal, the received signal comprising two or more diversity signals formed using a spreading technique at a transmitter, the method comprising the steps of:
estimating a channel over which the received signal was transmitted;
applying an inverse of the estimated channel to the received signal, thereby generating a compensated signal and an estimate of noise in each channel; and
using the estimated noise in each channel, from the channel estimation process, to weight inputs to demodulation of the compensated signal.

2. The method as claimed in claim 1, further comprising the step of performing a maximum ratio combining process to combine the two or more diversity signals prior to demodulation, the estimated noise in each channel being used to weight the two or more diversity signals during the maximum ratio combining process.

3. The method as claimed in claim 1, wherein the estimate of noise in each channel is an approximation based on the inverse of the estimated channel.

4. The method as claimed in claim 1, wherein the received signal is an ultra-wideband signal.

5. A receiver for processing a received signal comprising two or more diversity signals formed using a spreading technique at a transmitter, the receiver comprising:
channel estimation means for estimating a channel over which the received signal was transmitted;
inverting means for inverting the channel estimate obtained from the channel estimation means, an inverse of the estimated channel being applied to the received signal to generate a compensated signal; and
means for weighting the compensated signal prior to demodulation using an estimate of noise in each channel, the estimate of the noise in each channel being derived from the inverse of the channel estimation process.

6. The receiver as claimed in claim 5, further comprising means for performing a maximum ratio combining process to combine the two or more diversity signals prior to demodulation, the estimated noise in each channel being used to weight the two or more diversity signals during the maximum ratio combining process.

7. The receiver as claimed in claim 5, wherein the estimate of noise in each channel is an approximation based on the inverse of the estimated channel.

8. The receiver as claimed in claim 5, wherein the receiver is an ultra-wideband receiver for receiving an ultra-wideband signal.
